(19) United States
(12) Patent Application Publication
(10) Pub. No.: US 2004/0155971 A1
(43) Pub. Date: Aug. 12, 2004

(54) Method and system for building a view of an object

(76) Inventors: Manish Sharma, Mountain View, CA (US); Janice H. Nickel, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/360,461

(22) Filed: Feb. 6, 2003

(51) Int. Cl. H04N 5/262

(52) U.S. Cl. 348/239

(57) ABSTRACT

The present invention includes a method and system for building a view of an object captured with an image-capturing device. According to various embodiments of the present invention, a method and system are provided for building a view of an object based on the tilt angle of the image-capturing device when an image of the object is captured. Through the use of the method and system in accordance with the present invention, a tilt angle determination mechanism can be utilized to build views of objects based on the tilt angle of the image-capturing device. The method and system includes capturing an image of the object with an image capturing device, recording a tilt angle of the image capturing device and building a view of the object based on the tilt angle of the image capturing device.

### FIELD OF THE INVENTION

The present invention relates to the field of digital cameras, and more particularly relates to a method and system for building a view of an object.

### BACKGROUND OF THE INVENTION

In digital cameras, images are represented by data and stored either in the camera's memory or an external memory device from which they can be accessed by a user. A significant advantage to digital cameras is that users then have the capability to manipulate the image data in a number of ways. Users are able to operate on and modify the images, transfer them to other devices, incorporate them into documents, display them in a variety of formats, and the like. Thus, in comparison to conventional cameras, digital cameras introduce a variety of capabilities and enhancements.

The digital camera incorporates a central processing unit, memory, and many other features of a computer system. Accordingly, the digital camera is capable of concurrently running multiple software routines and subsystems to control and coordinate the various processes of the camera. One subsystem of particular interest is the image processing subsystem that is used for analyzing and manipulating captured image data in a variety of ways, including linearization, defect correction, white balance, interpolation, color correction, image sharpening, and color space conversion. In addition, the subsystem typically coordinates the functioning and communication of the various image processing stages and handles the data flow between the various stages.

Most digital cameras today are similar in size to and behave like conventional point-and-shoot cameras. Unlike conventional cameras, however, most digital cameras store digital images in an internal flash memory or on external memory cards, and some are equipped with a liquid-crystal display (LCD) screen on the back of the camera. Through the use of the LCD, most digital cameras operate in two modes, record and play, although some only have a record mode. In record mode, the LCD is used as a viewfinder in which the user may view an object or scene before taking a picture. In play mode, the LCD is used as a playback screen for allowing the user to review previously captured images either individually or in arrays of four, nine, or sixteen images. Digital cameras can typically be coupled with a peripheral display, such as a television set or a computer display. In this manner, the user may view the various images stored within the digital camera on a larger display.

Sometimes a camera user will tilt the camera, when capturing an image of an object, in order to get a shot of the object at a different angle. This presents a problem when it comes time to view the image of the object on the LCD screen of the camera. Because the user tilted the camera, an accurate view of the object cannot be generated since the tilt angle of the camera, at the time the image of the object is captured, has a tendency to cause distortions in captured image of the object.

Accordingly, what is needed is a method and system that allows a digital camera user to generate accurate views of the object regardless of the tilt angle of the camera at the time an image of the object is captured by the camera. The method and system should be simple, cost effective and capable of being easily adapted to existing technology. The present invention addresses these needs.

### SUMMARY OF TILE INVENTION

The present invention includes a method and system for building a view of an image captured with an image-capturing device. According to the present invention, a method and system is provided for building a view of an object based on the tilt-angle of the image capturing device when an image of the object is captured. Through the use of the method and system in accordance with the present invention, a tilt angle determination mechanism can be utilized to accurately build 3-Dimensional (3D) views of objects based on the tilt angle of the image-capturing device.

A first aspect of the present invention includes a method of building a view of an object. The method includes capturing an image of the object with an image capturing device, recording a tilt angle of the image capturing device and building a view of the object based on the tilt angle of the image capturing device.

A second aspect of the present invention includes an image processing system. The image processing system includes an image capturing device capable of determining a tilt angle thereof in relation to a reference axis and a system coupled to the image-capturing device wherein the system is capable of building a view of an object, wherein an image of the object is captured by the image capturing device, based on the tilt angle of the image-capturing device.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a high-level flow chart of a method in accordance with an embodiment of the present invention.

FIG. 2 is a block diagram of an image capturing device according to an embodiment of the present invention.

FIG. 3 is a more detailed block diagram of an imaging device according to an embodiment of the present invention.

FIG. 4 a more detailed block diagram of an internal computer according to an embodiment of the present invention.

FIG. 5A shows an image-capturing device in a normal position in accordance with an embodiment of the present invention.

FIG. 5B shows a perspective view of a tilt angle of an image-capturing device in accordance with an embodiment of the present invention.

FIG. 6 shows two image-capturing devices placed at different locations with respect to an object in accordance with an alternate embodiment of the present invention.

FIG. 7 shows an image processing system in accordance with an embodiment of the present invention.

FIG. 8 an illustration of a PC that can be utilized in conjunction with the image processing system in accordance with an embodiment of the present invention.

FIG. 9 is a flowchart of a method in accordance with an alternate embodiment of the present invention.

### DETAILED DESCRIPTION

The present invention relates to a method and system for building a view of an object. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention includes a method and system for building a view of an image captured with an image-capturing device. According to the present invention, a method and system is provided for building a view of an object based on the tilt-angle of the image capturing device when an image of the object is captured. Through the use of the method and system in accordance with the present invention, a tilt angle determination mechanism can be utilized to accurately build 3-Dimensional (3D) views of objects based on the tilt angle of the image-capturing device.

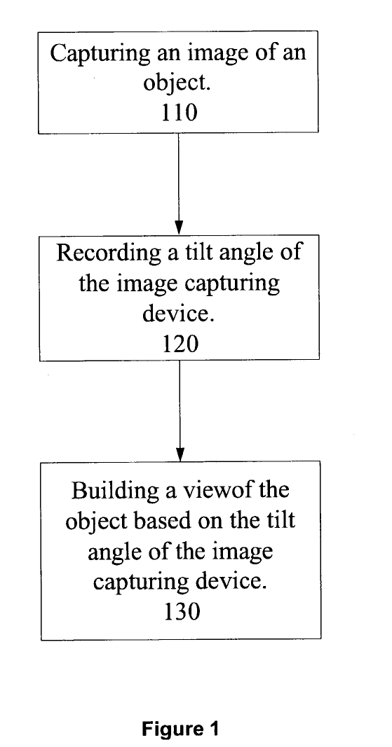

For a further understanding of the present invention, please refer now to FIG. 1. FIG. 1 is a flowchart of a method in accordance with an embodiment of the present invention. A first step 110 includes capturing an image of an object. The next step 120 includes determining a tilt angle the image-capturing device. A final step 130 includes building a view of the object based on the tilt angle of the image-capturing device. This step can include utilizing image analysis techniques to build the view of the object in order to be displayed on a screen of the image-capturing device or on a peripheral display coupled to the image-capturing device.

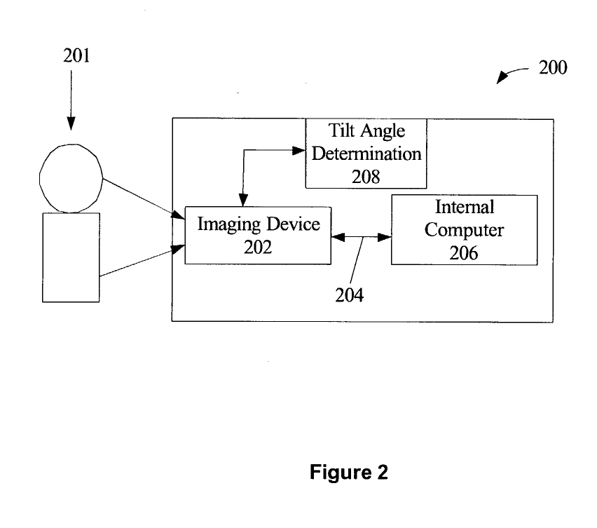

In an embodiment, step 10 is accomplished utilizing an image-capturing device such as a digital camera or the like. For an example of such a device, please refer to FIG. 2. FIG. 2 is a block diagram of an image-capturing device 200 in accordance with an embodiment of the present invention. Image-capturing device 200 can include an imaging device 202, a system bus 204, a computer 206 and a tilt-angle determination mechanism 208. Imaging device 202 can be optically coupled to an object 201 and electrically coupled via system bus 204 to computer 206.

The tilt-angle determination mechanism 208 can be coupled to the imaging device 202. Once a photographer has focused imaging device 202 on object 201 and, using a capture button or some other means, instructed image-capturing device 200 to capture an image of object 201, computer 206 can command the imaging device 202 via system bus 204 to capture raw image data representing object 201. The captured raw image data can be transferred over system bus 204 to computer 206 which performs various image processing functions on the image data before storing it in its internal memory. System bus 204 also passes various status and control signals between imaging device 202 and computer 206.

Although the above image-capturing device of the present invention is described in the context of being a digital camera, one of ordinary skill in the art will readily recognize that the image-capturing device can be a mobile phone, a personal-digital-assistant (PDA) or a variety of other devices, while remaining within the spirit and scope of the present invention.

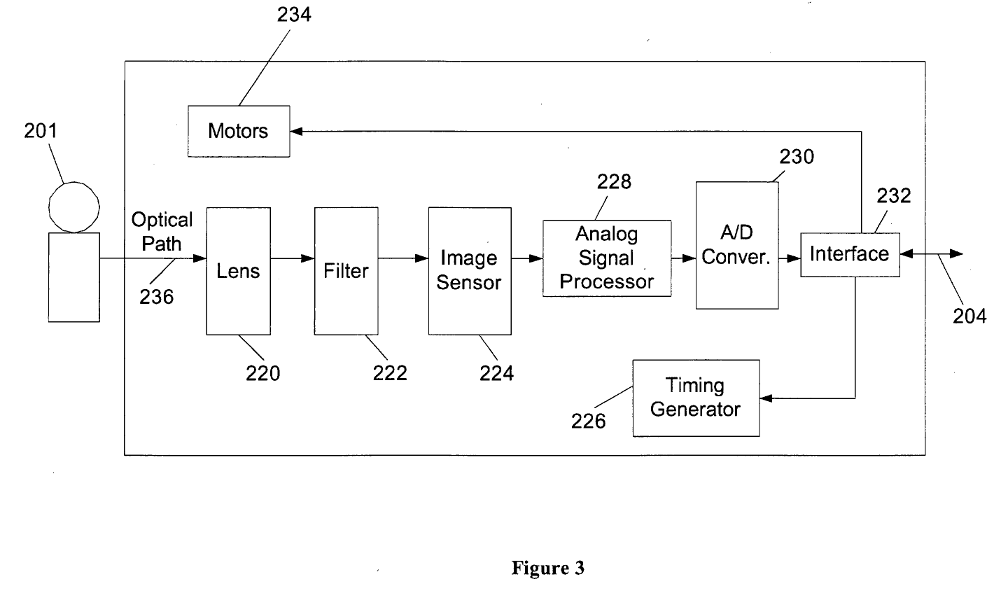

Referring now to FIG. 3, a more detailed block diagram of an embodiment of the imaging device 202 is shown. Imaging device 202 can be a lens 220 having an iris, a filter 222, an image sensor 224, a timing generator 226, an analog signal processor (ASP) 228, an analog-to-digital (A/D) converter 230, an interface 232, and one or more motors 234.

In operation, imaging device 202 captures an image of object 201 via reflected light impacting image sensor 224 along optical path 236. Image sensor 224 responsively generates a set of raw image data representing the captured image. The raw image data can then be routed through ASP 228, A/D converter 230 and interface 232. Interface 232 has outputs for controlling ASP 228, motors 234 and timing generator 226. From interface 232, the raw image data passes over system bus 204 to the internal computer 206 (Refer to FIG. 2).

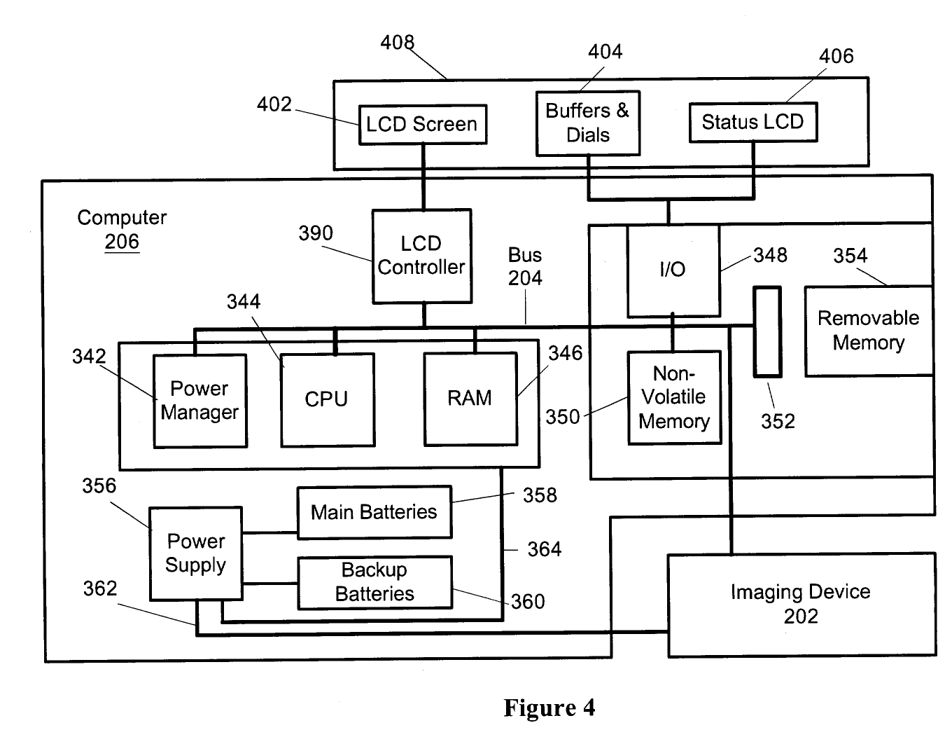

Referring now to FIG. 4, a more detailed block diagram of an embodiment of the internal computer 206 is shown. System bus 204 provides connection paths between imaging 111 device 202, power manager 342, central processing unit (CPU) 344, random-access memory (DRAM, MRAM, FeRAM, etc.) 346, input/output interface (I/O) 348, read-only memory (ROM) 350, and buffers/connector 352. Removable memory 354 connects to system bus 204 via buffers/connector 352. Alternately, image-capturing device 200 may be implemented without removable memory 354 or buffers/connector 352.

Power manager 342 communicates via line 366 with power supply 356 and coordinates power management operations for image-capturing device 200. CPU 344 typically includes a conventional processor device for controlling the operation of image-capturing device 200. In an embodiment, CPU 344 can be capable of concurrently running multiple software routines to control the various processes of image-capturing device 200 within a multi-threading environment. RAM 346 can be a contiguous block of dynamic memory which may be selectively allocated to various storage functions.

I/O 348 can be an interface device allowing communications to and from computer 206. For example, I/O 348 permits an external host computer (not shown) to connect to and communicate with computer 206. I/O 348 also permits an image-capturing device 200 user to communicate with image-capturing device 200 via an external user interface and via an external display panel. This is referred to as a view finder.

ROM 350 can include a nonvolatile read-only memory which stores a set of computer-readable program instructions to control the operation of image-capturing device 200. Removable memory 354 serves as an additional image data storage area and is preferably a non-volatile device, readily removable and replaceable by a image-capturing device 200 user via buffers/connector 352. Thus, a user who possesses several removable memories 354 may replace a full removable memory 354 with an empty removable memory 354 to effectively expand the picture-taking capacity of image-capturing device 200. In an embodiment of the present invention, removable memory 354 is typically implemented using a flash disk.

Power supply 356 supplies operating power to the various components of image-capturing device 200. In an embodiment, power supply 356 provides operating power to a main power bus 362 and also to a secondary power bus 364. The main power bus 362 provides power to imaging device 202, I/O 348, ROM 350 and removable memory 354. The secondary power bus 364 provides power to power manager 342, CPU 344 and RAM 346.

Power supply 356 can be connected to main batteries 358 and also to backup batteries 360. In an embodiment, a user of the image-capturing device 200 may also connect power supply 356 to an external power source. During normal operation of power supply 356, the main batteries 358 provide operating power to power supply 356 which then provides the operating power to image-capturing device 200 via both main power bus 362 and secondary power bus 364.

During a power failure mode in which the main batteries 358 have failed, the backup batteries 360 provide operating power to power supply 356 which then provides the operating power only to the secondary power bus 364 of image-capturing device 200. Selected components of image-capturing device 200 (including RAM 346) are thus protected against a power failure in main batteries 358.

Power supply 356 can also include a flywheel capacitor connected to the power line coming from the main batteries 358. If the main batteries 358 suddenly fail, the flywheel capacitor temporarily maintains the voltage from the main batteries 358 at a sufficient level, so that computer 206 can protect any image data currently being processed by image-capturing device 200 before shutdown occurs.

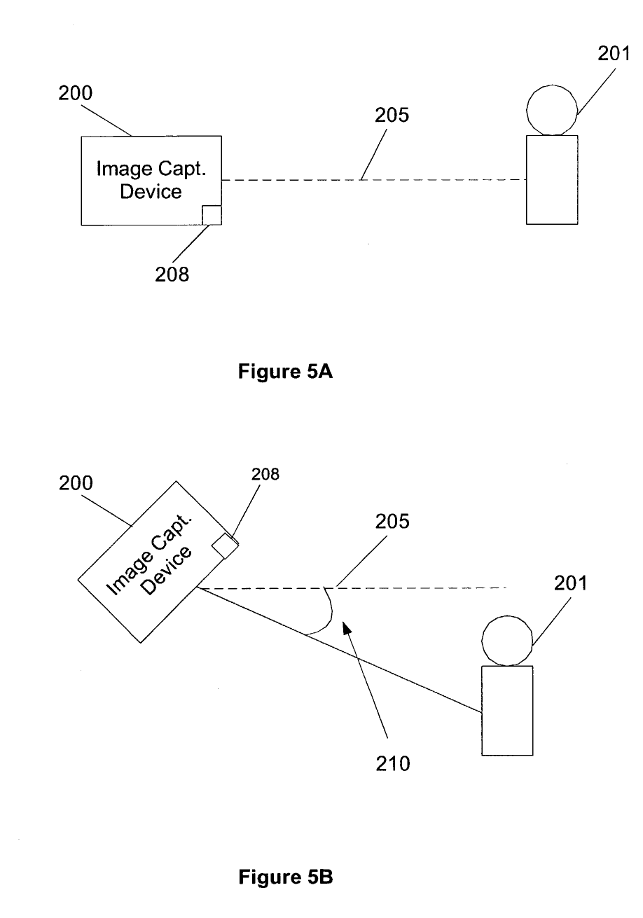

Referring back to FIG. 1, in an embodiment, step 120 can be accomplished utilizing a tilt angle determination mechanism 208 coupled within the image-capturing device 200. The tilt angle determination mechanism 208 is capable of determining the tilt angle of the image capturing device 200 at the time the image capturing device 200 captures an image of an object. For a better understanding, please refer to FIGS. 5A and 5B. FIG. 5A shows an image capturing device 200 in a normal position. In the normal position, the tilt angle of the image capturing device 200 is 0° with respect to a reference axis. In an embodiment, the reference axis is the horizontal plane 205. When the tilt angle of the image capturing device 200 is level (±5-10°), the image of the object 201 is captured by the image capturing device 200 and stored as an image file in a regular fashion.

However, if the tilt angle of the image capturing device 200 is not level with respect to the reference axis 205, then the tilt angle determination mechanism 208, determines the tilt angle of the image capturing device 200 with respect to the reference axis 205 and stores this information in the image file of the captured image. In an embodiment, the orientation of the image-capturing device 200 is stored in the image file header. A file header is the first part of the image file and contains controlling data as well as the structural layout of the contents of the image file.

For a better understanding, please refer to FIG. 5B. FIG. 5B is a perspective view of a tilt angle 210 of an image-capturing device 200 in accordance with an embodiment of the present invention. As can be seen in FIG. 5B, the tilt angle 210 is approximately 45° from the reference axis 205. Accordingly, the tilt angle determination mechanism 208, determines the tilt angle 210 of the image capturing device 200 with respect to the reference axis 205 and subsequently stores this information in the associated image file. Once the tilt angle information is stored in the associated image file, image analysis software can build a view of the image based on the tilt angle of the image-capturing device.

An embodiment of the tilt angle determination mechanism 208 includes an artificial horizon indicator. An artificial horizon indicator, can include a gyro that is mounted on a horizontal plane of rotation. In accordance with an embodiment of the present invention, as the image capturing device 200 is tilted at various angles, the gyro remains in the position on the horizontal plane. Consequently, the indicator can be utilized to record the tilt angle of the image-capturing device 200 when an image is captured by the image-capturing device 200. The tilt angle information can then be stored in an associated image file.

Although the above-described embodiment of the present invention is described in the context of being implemented in conjunction with an artificial horizon indicator, one of ordinary skill in the art will readily recognize that a variety of devices can be utilized to determine the tilt angle of the image capturing device 200 with respect to the reference axis while remaining within the spirit and scope of the present invention. For example, one or more level indicators can be utilized in combination with one or more sensors to determine the correct tilt angle.

Additionally, in an embodiment of the present invention, the tilt angle determination capability of the image capturing device 200 can be turned on or off by the user. Accordingly, the image capturing device 200 can operate in a “re-build” mode whereby the tilt angle determination mechanism 208 determines the tilt angle of the image capturing device 200 with respect to a reference axis when an image of an object is captured and the tilt angle information is stored in the image file. Alternatively, the user can disable the tilt angle determination capability of the image-capturing device 200 via a switch, button, on board menu or other means, thus operating the image-capturing device 200 in a “normal” mode whereby image files are created without including the tilt angle information.

An alternate embodiment of the present invention includes the utilization of more than one lens to capture the image. In an embodiment this can be accomplished utilizing a stereoscopic camera. A stereoscopic camera is one that uses two or more lenses placed at different positions to capture and build a 3D view of an object. An embodiment includes two lenses placed approximately the same distance as the two eyes of a human. Another embodiment can include two or more lenses placed at different known positions in relation to an object.

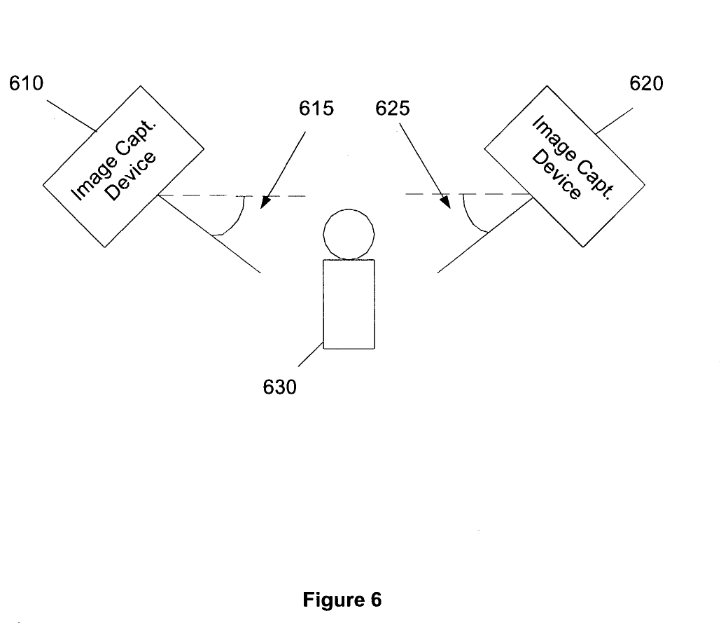

Accordingly, the tilt angle information from each lens is recorded in the resulting image file and utilized to accurately build a 3D view of the object. FIG. 6 shows two image-capturing devices 610, 620 placed at different locations with respect to an object in accordance with an alternate embodiment of the present invention. Also shown are the respective tilt angles 615, 625 of the two image-capturing devices 610, 620. Accordingly, once an image of the object 630 has been captured, the tilt angles 615, 625 of each of the image-capturing devices 610, 620 can be utilized in conjunction with image analysis techniques to build a 3D view of the object 630.

Although the above-described embodiment shows two image-capturing devices, one of ordinary skill in the art will readily recognize that a plurality of image-capturing devices can be utilized in conjunction with each other to build a view of the object while remaining within the spirit and scope of the present invention.

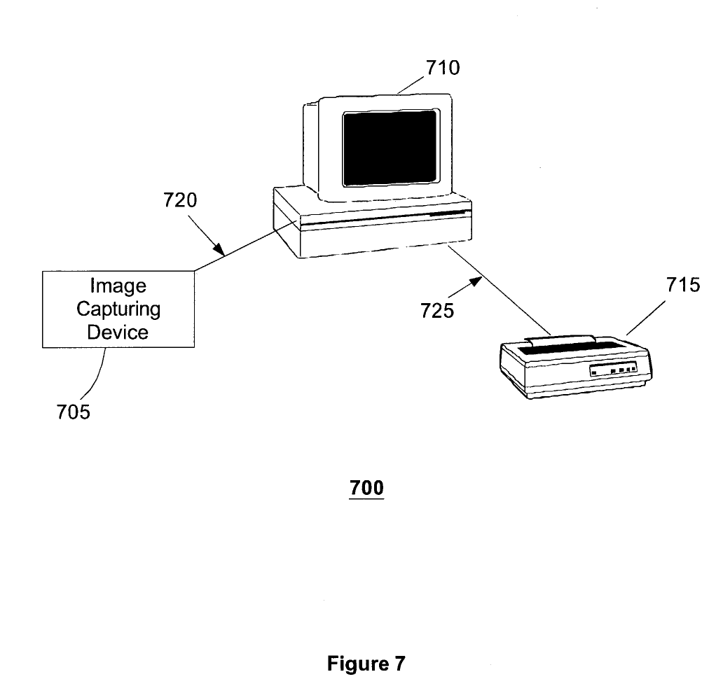

An alternate embodiment of the present invention includes an image processing system. As shown in FIG. 7, the image processing system 700 includes an image capturing device 705 (similar to image capturing device 200), a personal computer system (PC) 710, and a printer 715. The image capturing device 705 and PC 710 can be connected to each other via a communication cable 720 such as an RS232C cable and the PC 710 and printer 715 are connected to each other via a communication cable 725 such as a Centronics cable.

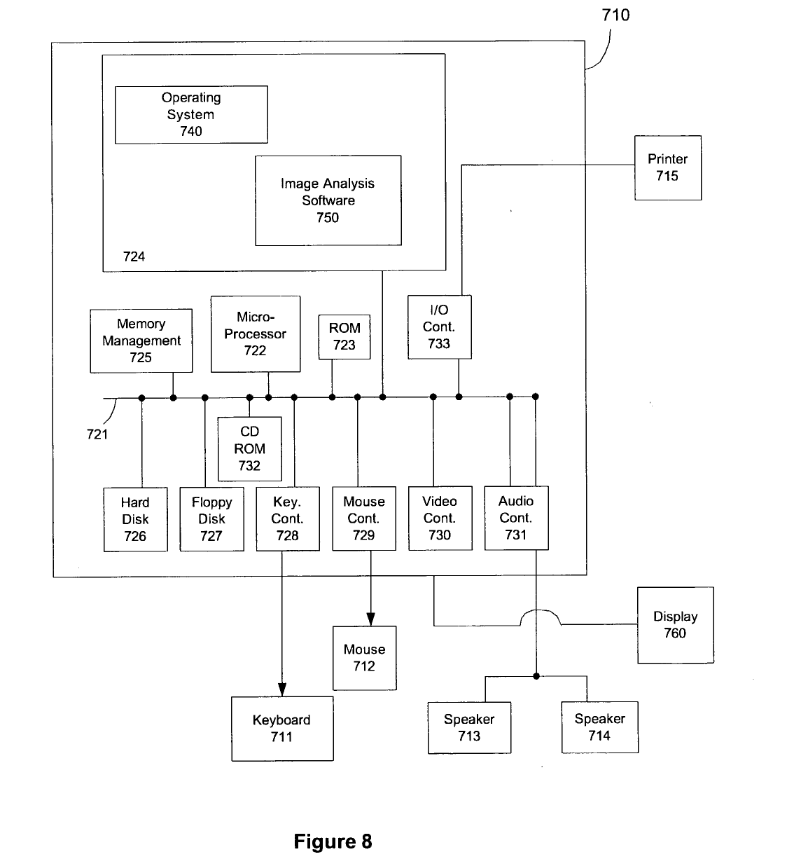

As shown above, the image processing system 700 can include a PC 710. For an example of such a PC, please refer now to FIG. 8. FIG. 8 is an illustration of a PC 710 that can be utilized in conjunction with the image processing system 700. The PC 710, including, a keyboard 711, a mouse 712 and a printer 715 are depicted in block diagram form. The PC 710 includes a system bus or plurality of system buses 721 to which various components are coupled and by which communication between the various components is accomplished. The microprocessor 722 is connected to the system bus 721 and is supported by read only memory (ROM) 723 and random access memory (RAM) 724 also connected to the system bus 721. A microprocessor is one of the Intel family of microprocessors including the 386, 486 or Pentium microprocessors. However, other microprocessors including, but not limited to, Motorola's family of microprocessors such as the 68000, 68020 or the 68030 microprocessors and various Reduced Instruction Set Computer (RISC) microprocessors such as the PowerPC chip manufactured by IBM. Other RISC chips made by Hewlett Packard, Sun, Motorola and others may be used in the specific computer.

The ROM 723 contains, among other code, the Basic Input-Output system (BIOS) which controls basic hardware operations such as the interaction of the processor and the disk drives and the keyboard. The RAM 724 is the main memory into which the operating system 740 and image analysis software 750 are loaded. The memory management chip 725 is connected to the system bus 721 and controls direct memory access operations including, passing data between the RAM 724 and hard disk drive 726 and floppy disk drive 727. The CD ROM 732 also coupled to the system bus 721 is used to store a large amount of data, e.g., a multimedia program or presentation.

Various I/O controllers are also connected to this system bus 721. These I/O controllers can include a keyboard controller 728, a mouse controller 729, a video controller 730, and an audio controller 731. As might be expected, the keyboard controller 728 can provide the hardware interface for the keyboard 711, the mouse controller 729 can provide the hardware interface for mouse 712, the video controller 730 can provide the hardware interface for the display 760, and the audio controller 731 can provide the hardware interface for the speakers 713, 714. Another I/O controller 733 can enable communication with the printer 715.

One of ordinary skill in the art will readily recognize that the PC 710 can include a personal-digital-assistant (PDA), a laptop computer or a variety of other devices while remaining within the spirit and scope of the present invention.

The PC 710 may also be utilized in conjunction with a distributed computing environment where tasks are performed by remote processing devices that are linked through a communications network The network may include LANnets, a WANnets, the Internet and/or an Intranet. Client terminals can include personal computers, stand-alone terminals, and organizational computers. The stand-alone terminal may include hardware for loading smart cards, reading magnetic cards, and processing videographics. The servers can include information servers, transactional servers and/or an external server. A transactional server may perform financial and/or personal transactions. The network can include a graphical user interface for displaying a portion of the characteristic data on client terminals. The system may be operable with a plurality of third party applications. Additionally, the networks can communicate via wireless means or any of a variety of communication means while remaining within the spirit and scope of the present invention.

Referring back to FIG. 7, an image captured by the image capturing device 705 can be temporarily stored as image data in an image file within the image capturing device 200. Accordingly, the tilt angle information can be stored in the image file as well. When the sensed image is to be displayed by the PC 710, image capturing device 705 and PC 710 are connected using the communication cable 720, and image analysis software installed on the PC 710 is started. Communications between the PC 710 and the image capturing device 705 are done via communication software, and the image data stored in the image file is transmitted from the flash memory of the image capturing device 705 to the PC 710 via the communication cable 720.

The transmitted image data can then be temporarily stored in the hard disk 726 (see FIG. 7) of the PC 710. The image can then be transmitted from the hard disk 726 to the display 760 (see FIG. 7) for viewing by the user. In an embodiment, the image analysis software 750 can retrieve the tilt angle information from the header of the transmitted image file and build a view of the image of the object based on the tilt angle information.

Additionally, when the image data transmitted from the image capturing device 705 is stored in the PC 710, the PC 710 starts a printer driver for the printer 715, the image data captured from the image capturing device 705 is converted into print data that can be printed by the printer 715 via the printer driver, and the converted print data is output to the printer 715 via the communication cable 725. The printer 715 receives the print data via the communication cable 725, and prints the view of the object onto a print paper sheet.

Although the above-described embodiment includes cable connections, one of ordinary skill in the art will readily recognize that a variety of connections can be utilized. For example, a wireless connection, such as an Infra-Red connection or a Bluetooth radio link can be employed. Bluetooth is an open standard for short-range transmission of digital voice and data between mobile devices (laptops, PDAs, phones) and desktop devices. It supports point-to-point and multipoint applications. Unlike Infra-Red, which requires that devices be aimed at each other (line of sight), Bluetooth uses omni-directional radio waves that can transmit through walls and other non-metal barriers. Bluetooth transmits in the unlicensed 2.4 GHz band and uses a frequency hopping spread spectrum technique that changes its signal 1600 times per second. If there is interference from other devices, the transmission does not stop, but its speed is downgraded.

Additionally, in an embodiment of the present invention, the image analysis software can be configured to operate in a “re-build” mode whereby the image analysis software actively searches the image file to find the tilt angle information of the image in order to determine the tilt angle of the image capturing device 705 when the image is captured. Alternatively, the user can disable this feature, thus allowing the image analysis software to operate in a “normal” mode whereby image files can be displayed without taking into account the tilt angle of the image-capturing device when the image was captured.

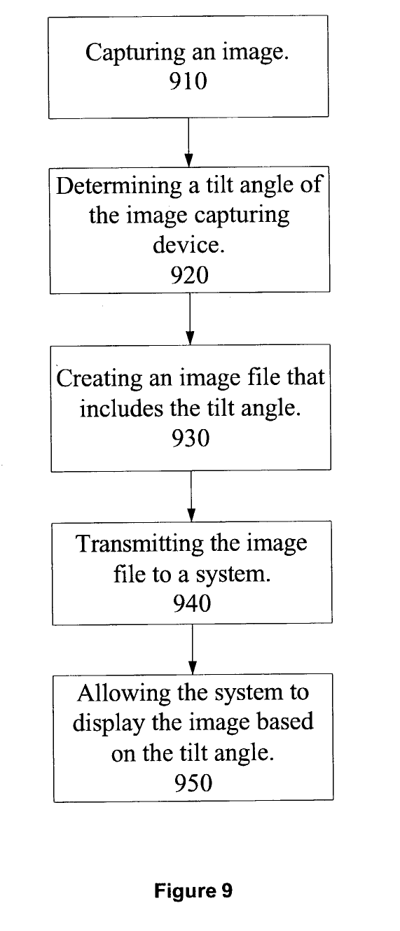

For a better understanding, please refer to FIG. 9. FIG. 9 is a flowchart of a method in accordance with an alternate embodiment of the present invention. First, an image of an object is captured with an image-capturing device, via step 910. Next, the tilt angle of the image-capturing device is determined, via step 920. This can be accomplished with a tilt-angle determination mechanism within the image-capturing device. An image file is then created that includes the tilt angle of the image-capturing device, via step 930. The image file is then transmitted to a system, via step 940. In an embodiment, the system is a personal computer. Finally, the system builds a view of the object based on the tilt angle of the image-capturing device, via step 950. In an embodiment, image analysis software within the personal computer builds a view of the object based on the tilt angle of the image-capturing device.

The above-described embodiments of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine readable instructions executable by a digital data processor to perform the method in accordance with an embodiment of the present invention.

This computer readable media may comprise, for example, RAM (not shown) contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (e.g. a conventional “hard drive” or a RAID array), magnetic tape, electronic read-only memory, an optical storage device (e.g., CD ROM, WORM, DVD, digital optical tape), paper “punch” cards, or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

The present invention includes a method and system for building images captured with an image-capturing device. According to various embodiments of the present invention, a method and system are provided for building an image based on the tilt angle of the image-capturing device when the image is captured. Through the use of the method and system in accordance with the present invention, a tilt angle determination mechanism can be utilized to build views of objects based on the tilt angle of the image-capturing device.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method of building a view of an object comprising:
capturing an image of the object with an image-capturing device;
recording a tilt angle of the image capturing device; and
building a view of the object based on the tilt angle of the image-capturing device.

2. The method of claim 1 wherein the image capturing device includes a tilt angle determination mechanism and recording the tilt angle of the image further comprises:
utilizing the tilt angle determination mechanism to determine the tilt angle of the image-capturing device.

3. The method of claim 2 wherein the tilt angle determination mechanism comprises an artificial horizon indicator.

4. The method of claim 3 wherein the image capturing device comprises a digital camera.

5. The method of claim 3 the image capturing device comprises a mobile phone.

6. The method of claim 1 wherein the image is included in an image file and recording a tilt angle of the image-capturing device further includes:
recording the tilt angle of the image-capturing device into the image file.

7. The method of claim 6 wherein building a view of the object based on the tilt angle further comprises:
utilizing image analysis techniques to build the view of the object based on the tilt angle of the image-capturing device.

8. The method of claim 1 wherein capturing the image further comprises:
utilizing more than one image-capturing device to capture the image.

9. The method of claim 1 wherein the image-capturing device comprises at least two lenses and capturing the image further comprises:
utilizing the at least two lenses to capture the image.

10. The method of claim 9 wherein recording a tilt angle of the image capturing device further comprises:
recording the tilt angle of each of the at least two lenses.

11. The method of claim 10 wherein building a view of the object based on the tilt angle further comprises:
utilizing image analysis techniques to build the view of the object based on the tilt angle of each of the at least two lenses.

12. The method of claim 11 wherein the image capturing device comprises a stereoscopic camera.

13. An image processing system comprising:
an image capturing device capable of determining a tilt angle thereof in relation to a captured image; and
a system coupled to the image-capturing device wherein the system is capable of building a view of an object, wherein an image of the object is captured by the image capturing device, based on the tilt angle of the image-capturing device.

14. The image processing system of claim 13 wherein the image capturing device includes a tilt angle determination mechanism.

15. The image processing system of claim 14 wherein the tilt angle determination mechanism comprises an artificial horizon indicator.

16. The image processing system of claim 15 wherein the image capturing device comprises a digital camera.

17. The image processing system of claim 15 wherein the image capturing device comprises a mobile phone.

18. The image processing system of claim 15 wherein the system includes means for utilizing image analysis techniques to build the view of the object based on the tilt angle of the image-capturing device.

19. The image processing system of claim 15 wherein the image capturing device comprises at least two lenses.

20. The image processing system of claim 19 wherein the system includes means for utilizing image analysis techniques to build the view of the object based on the tilt angle of each of the at least two lenses.

21. The image processing system of claim 20 wherein the image capturing device comprises a stereoscopic camera.

22. A computer program product for building a view of an object, the computer program product comprising a computer usable medium having computer readable program means for causing a computer to perform the steps of:
capturing an image of the object with an image-capturing device;
recording a tilt angle of the image capturing device; and
building a view of the object based on the tilt angle of the image-capturing device.

23. The computer program product of claim 22 wherein the image capturing device includes a tilt angle determination mechanism and recording the tilt angle of the image further comprises:
utilizing the tilt angle determination mechanism to determine the tilt angle of the image-capturing device.

24. The computer program product of claim 23 wherein the tilt angle determination mechanism comprises an artificial horizon indicator.

25. The computer program product of claim 23 wherein the image capturing device comprises a digital camera.

26. The computer program product of claim 23 wherein the image capturing device comprises a mobile phone.

27. The computer program product of claim 22 the image is included in an image file and recording a tilt angle of the image-capturing device further includes:
recording the tilt angle of the image-capturing device into the image file.

28. The computer program product of claim 27 wherein building a view of the object based on the tilt angle further comprises:
utilizing image analysis techniques to build the view of the object based on the tilt angle of the image-capturing device.

29. A digital camera comprising:
an imaging device for capturing an image of an object;
a system bus coupled to the imaging device;
a computer coupled to the system bus; and
a tilt angle determination mechanism coupled to the imaging device for determining the tilt angle of the image-capturing device.

30. The digital camera of claim 29 wherein the tilt angle determination mechanism 2 comprises an artificial horizon indicator.

31. The digital camera of claim 29 wherein the computer includes means for utilizing image analysis techniques to build a view of the object based on the tilt angle of the image-capturing device.

32. The digital camera of claim 29 wherein the imaging device further includes at least two lenses for capturing the image of the object.

33. The digital camera of claim 32 wherein the computer includes means for utilizing image analysis techniques to build a view of the object based on the tilt angle of each of the at least two lenses.
